(19) United States
(12) Patent Application Publication
(10) Pub. No.: US 2007/0093166 A1
(43) Pub. Date: Apr. 26, 2007

(54) IMAGE DISPLAY DEVICE AND METHOD OF MANUFACTURING THE SAME

(76) Inventors: Satoko Oyaizu, Fukaya-shi (JP); Satoshi Ishikawa, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/539,981

(22) Filed: Oct. 10, 2006

Related U.S. Application Data
(63) Continuation of application No. PCT/JP05/06946, filed on Apr. 8, 2005.

(30) Foreign Application Priority Data
Apr. 13, 2004 (JP) 2004-117908

(51) Int. Cl. H01J 9/24; H01J 9/26; H01J 9/00; H01J 9/32

(52) U.S. Cl. 445/24; 445/25

(57) ABSTRACT

An image display device includes an envelope having a first substrate and a second substrate located opposite the first substrate across a gap and a plurality of pixels provided in the envelope. A plurality of spacers that support an atmospheric load acting on the first and second substrates are provided between the first substrate and the second substrate in the envelope. Indentations with Ra of 0.2 to 0.6 μm and Sm of 0.02 to 0.3 mm are formed covering the whole surfaces of the spacers. An electrically conductive substance is put on the spacer surfaces, thereby forming divided coating films. Since the coating films are divided by the indentations, they can form films of higher resistance that can suppress electric discharge.

### CROSS-REFERENCE TO RELATED APPLICATIONS

This is a Continuation Application of PCT Application No. PCT/JP2005/006946, filed Apr. 8, 2005, which was published under PCT Article 21(2) in Japanese.

This application is based upon and claims the benefit of priority from prior Japanese Patent Application No. 2004-117908, filed Apr. 13, 2004, the entire contents of which are incorporated herein by reference.

### BACKGROUND OF THE INVENTION

1. Field of the Invention

This invention relates to an image display device, provided with substrates opposed to each other and spacers arranged between the substrates, and a manufacturing method therefor.

2. Description of the Related Art

In recent years, various flat image display devices have been noticed as a next generation of lightweight, thin display devices to replace cathode-ray tubes (CRTs). For example, a surface-conduction electron emission device (SED) has been developed as a kind of a field emission device (FED) that serves as a flat display device.

The SED comprises a first substrate and a second substrate that are opposed to each other across a predetermined gap. These substrates have their respective peripheral portions joined together by a rectangular sidewall, thereby constituting a vacuum envelope. Three-color phosphor layers are formed on the inner surface of the first substrate. Arranged on the inner surface of the second substrate are a large number of electron emitting elements, which correspond individually to pixels and serve as electron emission sources that excite the phosphors.

For the SED, it is important to maintain a high degree of vacuum in the space between the first substrate and the second substrate, that is, in the vacuum envelope. If the degree of vacuum is low, the life of the electron emitting elements, and therefore, the life of the device inevitably decrease. In order to support an atmospheric load that acts between the first substrate and the second substrate and maintain the gap between the substrates, as described in Jpn. Pat. Appln. KOKAI Publication No. 2001-272926, for example, a large number of plate-like or columnar spacers are located between the two substrates. In displaying an image, an anode voltage is applied to the phosphor layers, and electron beams emitted from the electron emitting elements are accelerated by the anode voltage and collided with the phosphor layers, whereupon the phosphors glow and display the image. In order to obtain practical display characteristics, it is necessary to use phosphors similar to those of conventional cathode ray tubes and set the anode voltage to several kilovolts or more, and preferably, to 5 kV or more.

If electrons with high acceleration voltage collide with a phosphor screen in the SED constructed in this manner, secondary electrons and reflected electrons are generated on the phosphor screen. If the space between the first and second substrates is narrow, the secondary electrons and reflected electrons generated on the phosphor screen collide with the spacers arranged between the substrates, whereupon the spacers are electrified. Normally, the spacers are positively charged with the acceleration voltage in the SED. In this case, the electron beams emitted from the electron emitting elements are attracted to the spacers and deviated from their original paths. In consequence, mislanding of the electron beams on the phosphor layers occurs, so that the color purity of the displayed image inevitably decreases.

If the spacers are electrified, electric discharge easily occurs near the spacers. If the spacer surfaces are coated with a low-resistance film in order to control the movement of the electron beams, in particular, electric discharge from the spacers occurs more easily. In this case, the dielectric strength properties of the SED may possibly be lowered.

### BRIEF SUMMARY OF THE INVENTION

This invention has been made in consideration of these circumstances, and its object is to provide an image display device, in which electrification of spacers is suppressed so that its dielectric strength properties and display quality are improved, and a manufacturing method therefor.

According to an aspect of the invention, there can be provided an image display device comprising: an envelope having a first substrate and a second substrate located opposite the first substrate across a gap; a plurality of pixels provided in the envelope; and a plurality of spacers which are provided between the first substrate and the second substrate in the envelope and support an atmospheric load acting on the first and second substrates, each of the spacers having a rugged surface formed of indentations with an arithmetic mean roughness Ra of 0.2 to 0.6 μm and a mean interval Sm of 0.02 to 0.3 mm, the rugged surface of each spacer having thereon divided coating films of an electrically conductive substance.

According to another aspect of the invention, there can be provided an image display device comprising: an envelope having a first substrate and a second substrate located opposite the first substrate across a gap; a plurality of pixels provided in the envelope; and a spacer structure which is provided between the first substrate and the second substrate in the envelope and supports an atmospheric load acting on the first and second substrates, the spacer structure having a supporting substrate provided opposite the first and second substrates and a plurality of spacers set up on at least one surface of the supporting substrate, a surface of each of spacers having a rugged surface formed of indentations with an arithmetic mean roughness Ra of 0.2 to 0.6 μm and a mean interval Sm of 0.02 to 0.3 mm, the rugged surface having thereon divided coating films of an electrically conductive substance.

According to still another aspect of the invention, there can be provided a method of manufacturing an image display device which comprises an envelope having a first substrate and a second substrate located opposite the first substrate across a gap, a plurality of pixels provided in the envelope, and a plurality of spacers which are provided between the first substrate and the second substrate in the envelope and support an atmospheric load acting on the first and second substrates, each said spacer having a rugged surface formed of indentations with an arithmetic mean roughness Ra of 0.2 to 0.6 μm and a mean interval Sm of 0.02 to 0.3 mm, the rugged surface of each spacer having thereon divided coating films of an electrically conductive substance, the method comprising: preparing a molding die having a plurality of spacer forming holes; loading each spacer forming hole of the molding die with a spacer forming material; curing the spacer forming material in the spacer forming holes of the molding die and then releasing the cured material from the molding die; firing the released spacer material, thereby forming the spacers; partially dissolving the respective surfaces of the formed spacers with an acid-based liquid, thereby forming the indentations with the arithmetic mean roughness Ra of 0.2 to 0.6 μm and the mean interval Sm of 0.02 to 0.3 mm over the whole surfaces of the spacers; and putting the electrically conductive substance on the rugged spacer surfaces, thereby forming the divided coating films.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an SED according to a first embodiment of this invention;

FIG. 2 is a perspective view of the SED, broken away along line II-II of FIG. 1;

FIG. 3 is a sectional view enlargedly showing the SED;

FIG. 4 is a sectional view enlargedly showing a part of the spacer structure;

FIG. 5 is a sectional view showing a supporting substrate and molding dies used in the manufacture of the spacer structure;

FIG. 6 is a side view showing a master male die used in the manufacture of the molding dies;

FIG. 7 is a sectional view showing a process for manufacturing a molding die using the master male die;

FIG. 8 is a sectional view showing an assembly in which the molding dies and the supporting substrate are in close with one another;

FIG. 9 is a sectional view showing a state in which the molding dies are open;

FIG. 10 is a diagram showing the relationship between resistance values and the performance of treatment with hydrochloric acid;

FIG. 11 is a graph showing the relationship between resistance values and the performance of treatment with hydrochloric acid;

FIG. 12 is a sectional view enlargedly showing a spacer structure of an SED according to a second embodiment of this invention;

FIG. 13 is a sectional view enlargedly showing a part of an SED according to a third embodiment of this invention; and

FIG. 14 is a sectional view enlargedly showing a spacer structure of the SED according to the third embodiment.

### DETAILED DESCRIPTION OF THE INVENTION

A first embodiment in which this invention is applied to an SED as a flat image display device will now be described in detail with reference to the drawings.

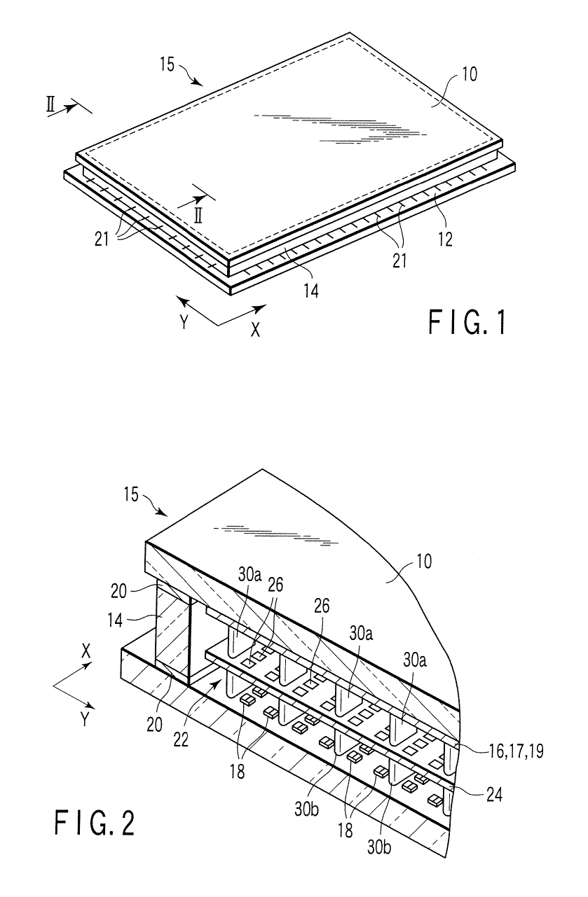

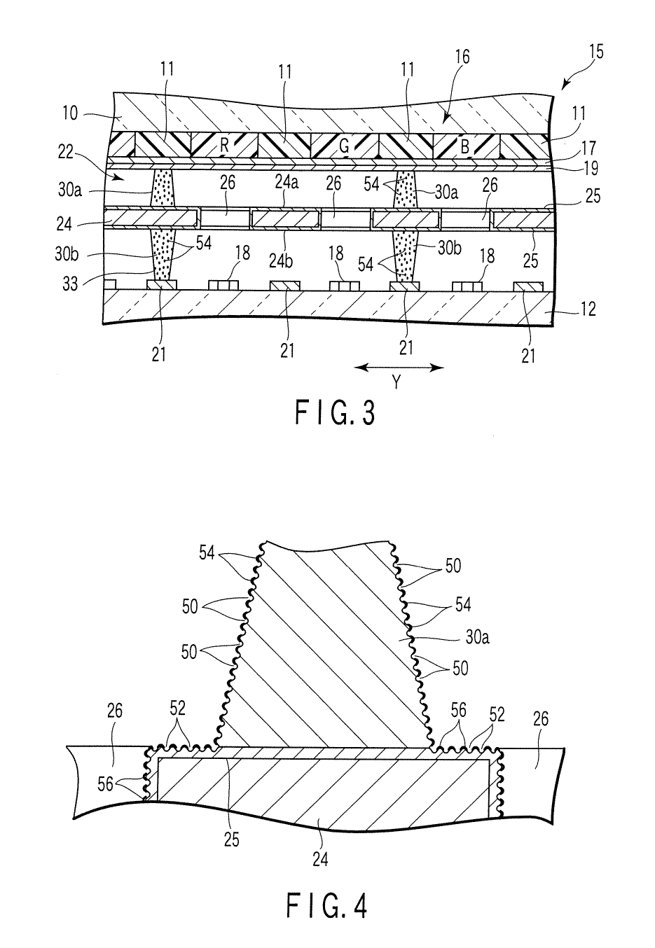

As shown in FIGS. 1 to 3, the SED comprises a first substrate 10 and a second substrate 12, which are each formed of a rectangular glass plate. These substrates are located opposite each other with a gap of about 1.0 to 2.0 mm between them. The first substrate 10 and the second substrate 12 have their respective peripheral edge portions joined together by a sidewall 14 of glass in the form of a rectangular frame, thereby forming a flat vacuum envelope 15 the inside of which is kept evacuated.

A phosphor screen 16 that functions as a phosphor screen is formed on the inner surface of the first substrate 10. The phosphor screen 16 is composed of phosphor layers R, G and B, which glow red, green, and blue, respectively, and light shielding layers 11 arranged side by side. These phosphor layers are stripe-shaped, dot-shaped, or rectangular. A metal back 17 of aluminum or the like and a getter film 19 are successively formed on the phosphor screen 16.

Provided on the inner surface of the second substrate 12 are a large number of surface-conduction electron emitting elements 18, which individually emit electron beams as electron sources for exciting the phosphor layers R, G and B of the phosphor screen 16. These electron emitting elements 18 are arranged in a plurality of columns and a plurality of rows and form pixels in conjunction with their corresponding phosphor layers. Each electron emitting element 18 is formed of an electron emitting portion (not shown), a pair of element electrodes that apply a voltage to the electron emitting portion, etc. A large number of wires 21 for supplying potential to the electron emitting elements 18 are provided in a matrix on the inner surface of the second substrate 12, and their respective end portions are led out of the vacuum envelope 15.

The sidewall 14 that functions as a joint member is sealed to the peripheral edge portion of the first substrate 10 and the peripheral edge portion of the second substrate 12 with a sealant 20 of, for example, low-melting-point glass or low-melting-point metal, whereby these substrates are joined together.

As shown in FIGS. 2 to 4, the SED comprises a spacer structure 22 that is located between the first substrate 10 and the second substrate 12. In the present embodiment, the spacer structure 22 has a rectangular supporting substrate 24 located between the first and second substrates 10 and 12 and a large number of columnar spacers set up integrally on the opposite surfaces of the supporting substrate.

Specifically, the supporting substrate 24 has a first surface 24a opposed to the inner surface of the first substrate 10 and a second surface 24b opposed to the inner surface of the second substrate 12, and is located parallel to these substrates. A large number of electron beam apertures 26 are formed in the supporting substrate 24 by etching or the like. The electron beam apertures 26 are arrayed in a plurality of rows and a plurality of columns so as to face the electron emitting elements 18, individually, and are permeated by the electron beams emitted from the electron emitting elements. If a longitudinal direction of the vacuum envelope 15 and a transverse direction perpendicular thereto are X and Y, respectively, the electron beam apertures 26 are individually arranged at predetermined pitches in the longitudinal direction X and the transverse direction Y. Here the pitches in the transverse direction Y are larger than the pitches in the longitudinal direction X.

The supporting substrate 24 is formed of a plate of, for example, an iron-nickel-based metal with a thickness of 0.1 to 0.3 mm. An oxide film of elements that constitute the metal plate, e.g., an oxide film of Fe₃O₄ or NiFe₂O₄, is formed on the surfaces of the supporting substrate 24. The surfaces 24a and 24b of the supporting substrate 24 and the respective wall surfaces of the electron beam apertures 26 are covered by a dielectric layer 25 that has a discharge current limiting effect. The dielectric layer 25 is formed of a high-resistance substance that consists mainly of glass.

A plurality of first spacers 30a are set up integrally on the first surface 24a of the supporting substrate 24 and are individually situated between the adjacent electron beam apertures 26. The respective distal ends of the first spacers 30a abut against the inner surface of the first substrate 10 through the getter film 19, the metal back 17, and the light shielding layers 11 of the phosphor screen 16.

A plurality of second spacers 30b are set up integrally on the second surface 24b of the supporting substrate 24 and are individually situated between the adjacent electron beam apertures 26. The respective distal ends of the second spacers 30b abut against the inner surface of the second substrate 12. In this case, the distal ends of the second spacers 30b are situated individually on the wires 21 that are provided on the inner surface of the second substrate 12. The first and second spacers 30a and 30b are arrayed at pitches several times larger than those of the electron beam apertures 26 in the longitudinal direction X and the transverse direction Y. The first and second spacers 30a and 30b are situated in alignment with one another and are formed integrally with the supporting substrate 24 in a manner such that the supporting substrate 24 is held between them from both sides.

Each of the first and second spacers 30a and 30b is tapered so that its diameter is reduced from the side of the supporting substrate 24 toward its extended end. For example, each first spacer 30a has an elongated elliptic cross-sectional shape. It is formed so that a length of its proximal end on the side of the supporting substrate 24 in the longitudinal direction X is about 1 mm, a width in the transverse direction Y is about 300 μm, and a height in the extending direction of the first spacer is about 0.6 mm. Each second spacer 30b has an elongated elliptic cross-sectional shape. It is formed so that a length of its proximal end on the side of the supporting substrate 24 in the longitudinal direction X is about 1 mm, a width in the transverse direction Y is about 300 μm, and a height in the extending direction of the second spacer is about 0.8 mm. The first and second spacers 30a and 30b are provided on the supporting substrate 24 in a manner such that the longitudinal direction of their cross section is in line with the longitudinal direction X of the vacuum envelope 15.

As shown in FIG. 4, each of the first and second spacers 30a and 30b has a rugged surface such that minute indentations 50 are formed covering its entire surface. The indentations 50 are formed having an arithmetic mean roughness Ra of 0.2 to 0.6 μm and a mean interval Sm of 0.02 to 0.3 mm. Minute indentations 52 with the arithmetic mean roughness Ra of 0.2 to 0.6 μm and the mean interval Sm of 0.02 to 0.3 mm are formed over the whole area of the dielectric layer 25 on the surface of the supporting substrate 24 but those areas on which the first and second spacers 30a and 30b are set up, thus forming a rugged surface.

Here the arithmetic mean roughness Ra is a value equal to an average of sum totals of absolute values of deviations from a mean line to a measurement curve, corresponding to an extracted portion with a reference length 1 that is extracted from a roughness curve in the direction of the mean line. The mean interval Sm of the indentations is a mean value in millimeters obtained from sums of the respective lengths of mean lines corresponding to each crest and its adjacent root after a portion with the reference length 1 is extracted from the roughness curve in the direction of the mean line.

An electrically conductive substance, e.g., chromium oxide, is put on the rugged surfaces of the first and second spacers 30a and 30b and forms divided coating films 54. Specifically, the coating films 54 are mainly put on projections of the rugged surfaces and are divided from one another. The electrically conductive substance is not limited to chromium oxide, but any other metal oxide such as copper oxide, metal nitride, or ITO may be used instead.

The spacer structure 22 constructed in this manner is arranged between the first substrate 10 and the second substrate 12. The first and second spacers 30a and 30b abut against the respective inner surfaces of the first substrate 10 and the second substrate 12, thereby supporting an atmospheric load that acts on these substrates and keeping the space between the substrates at a predetermined value.

The SED comprises voltage supply portions (not shown) that apply voltages to the supporting substrate 24 and the metal back 17 of the first substrate 10. The voltage supply portions are connected individually to the supporting substrate 24 and the metal back 17, and apply voltages of, e.g., 12 and 10 kV to the supporting substrate 24 and the metal back 17, respectively. In displaying an image on the SED, an anode voltage is applied to the phosphor screen 16 and the metal back 17, and electron beams emitted from the electron emitting elements 18 are accelerated by the anode voltage and collided with the phosphor screen 16. Thereupon, the phosphor layers of the phosphor screen 16 are excited to luminescence and display the image.

The following is a description of a method of manufacturing the SED constructed in this manner. A method of manufacturing the spacer structure 22 will be described first.

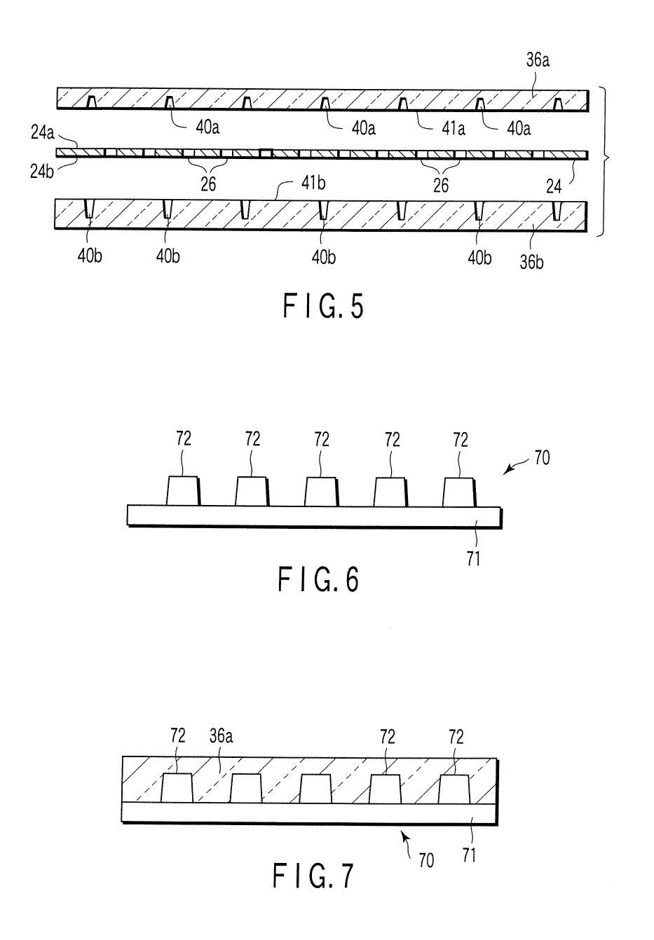

As shown in FIG. 5, the supporting substrate 24 with a predetermined size and an upper die 36a and a lower die 36b, each in the form of a rectangular plate having substantially the same size as the supporting substrate, are prepared. After a metal plate of Fe-50% Ni with a plate thickness of 0.12 mm is degreased, washed, and dried, in this case, the electron beam apertures 26 are formed by etching. After the entire metal plate is blackened, a solution that contains glass particles is applied by spraying to the surface of the supporting substrate including the respective inner surfaces of the electron beam apertures 26 and dried. Thereupon, the supporting substrate 24 is obtained having the dielectric layer 25 formed thereon.

The upper die 36a and the lower die 36b for use as molding dies are flat plates formed of a transparent material that transmits ultraviolet rays, e.g., clear silicone or clear polyethylene terephthalate. The upper die 36a has a flat contact surface 41a in contact with the supporting substrate 24 and a large number of bottomed spacer forming holes 40a for molding the first spacers 30a. The spacer forming holes 40a individually open in the contact surface 41a of the upper die 36a and are arranged at predetermined spaces. Likewise, the lower die 36b has a flat contact surface 41b and a large number of bottomed spacer forming holes 40b for molding the second spacers 30b. The spacer forming holes 40b individually open in the contact surface 41b of the lower die 36b and are arranged at predetermined spaces.

The upper die 36a and the lower die 36b are manufactured by the following processes. The following is a description of a method of manufacturing the upper die 36a as a representative. First, a master male die 70 for forming the upper die is formed by cutting, as shown in FIG. 6. In this case, a base plate 71 of, for example, brass is prepared and one surface of this base plate is cut, whereupon a plurality of oblong posts 72 are formed corresponding to the first spacers 30a, individually. Thereupon, the master male die 70 is obtained. After the upper die 36a is then molded by filling clear silicone into the master male die 70, as shown in FIG. 7, the die is released, whereupon the upper die is obtained. The lower die 36b is manufactured by similar processes.

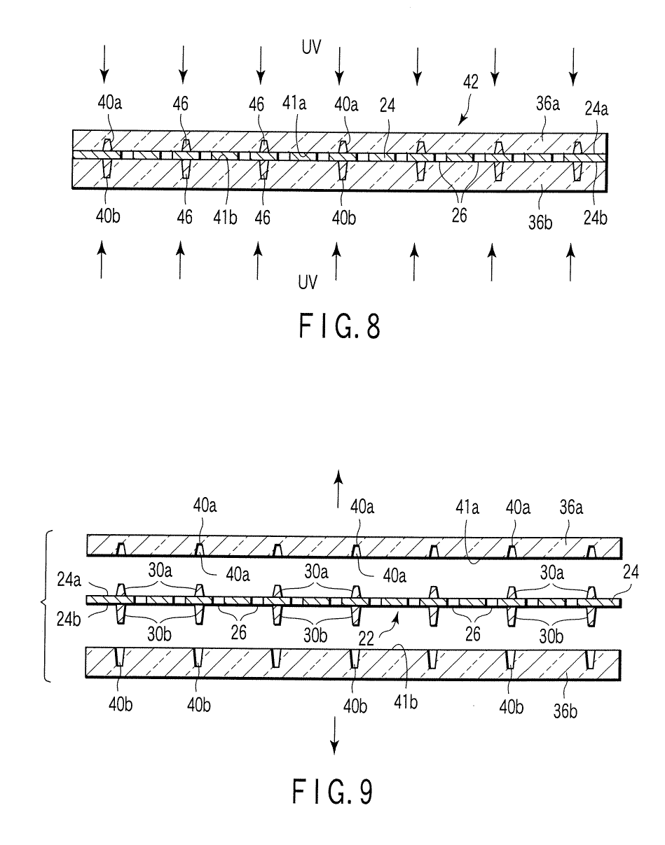

Then, the spacer forming holes 40a of the upper die 36a and the spacer forming holes 40b of the lower die 26b are loaded with a spacer forming material 46, as shown in FIG. 8. A glass paste that contains at least an ultraviolet-curing binder (organic component) and a glass filler is used as the spacer forming material 46. The specific gravity and viscosity of the glass paste are selected as required.

The upper die 36a is positioned so that the spacer forming holes 40a filled with the spacer forming material 46 individually face regions between the electron beam apertures 26, and the contact surface 41a is brought into close contact with the first surface 24a of the supporting substrate 24. Likewise, the lower die 36b is positioned so that the spacer forming holes 40b individually face regions between the electron beam apertures 26, and the contact surface 41b is brought into close contact with the second surface 24b of the supporting substrate 24. An adhesive may be previously applied to spacer setup positions on the supporting substrate 24 by means of a dispenser or by printing. Thus, an assembly 42 is formed having the supporting substrate 24, upper die 36a, and lower die 36b. In the assembly 42, the spacer forming holes 40a of the upper die 36a and the spacer forming holes 40b of the lower die 36b are arranged opposite one another with the supporting substrate 24 between them.

Ultraviolet (UV) rays are applied to the upper die 36a and the lower die 36b in close contact with the supporting substrate 24 from outside the upper die and the lower die. Since the upper die 36a and the lower die 36b are individually formed of an ultraviolet transmitting material, the radiated ultraviolet rays are transmitted through the upper die 36a and the lower die 36b and applied to the loaded spacer forming material 46. Thus, the spacer forming material 46 is ultraviolet-cured. Subsequently, the upper die 36a and the lower die 36b are released from the supporting substrate 24 with the cured spacer forming material 46 left on the supporting substrate 24, as shown in FIG. 9. In these processes, the spacer forming material 46 molded in a predetermined shape is transferred onto the surfaces of the supporting substrate 24.

Then, the supporting substrate 24 with the spacer forming material 46 thereon is heat-treated in a heating furnace so that the binder is evaporated from the spacer forming material, and the spacer forming material and the dielectric layer 25 formed on the supporting substrate 24 are then fired at about 500 to 550° C. for 30 minutes to 1 hour. The spacer forming material 46 and the dielectric layer 25 are vitrified by the firing, whereupon the spacer structure 22 is obtained having the first and second spacers 30a and 30b built-in on the supporting substrate 24.

Subsequently, the supporting substrate 24 and the first and second spacers 30a and 30b are immersed in a 0.1 to 10 wt % hydrochloric acid solution, whereby the respective surfaces of the first and second spacers 30a and 30b and the surface of the dielectric layer 25 of the supporting substrate 24 are partially dissolved. The uneven minute indentations 50 and 52 are formed on the respective surfaces of the first and second spacers 30a and 30b and the surface of the dielectric layer 25 of the supporting substrate 24. The indentations 50 and 52 are formed so that Ra and Sm range from 0.2 to 0.6 μm and from 0.02 to 0.3 mm, respectively, by adjusting the hydrochloric acid concentration of the solution, temperature, and immersion time or by adjusting the fluidity of the solution by agitation or the like.

After the indentations 50 and 52 are formed, an electrically conductive substance, e.g., chromium oxide, is put on the rugged surfaces of the first and second spacers 30a and 30b and the rugged surface of the dielectric layer 25 on the supporting substrate 24 by vapor deposition or sputtering and forms divided coating films 54 and 56.

In the manufacture of the SED, on the other hand, the first substrate 10, which is provided with the phosphor screen 16 and the metal back 17, and the second substrate 12, which is provided with the electron emitting elements 18 and the wires 21 and joined with the sidewall 14, are prepared in advance. Subsequently, the spacer structure 22 obtained in the aforesaid manner is positioned on the second substrate 12. In this state, the first substrate 10, second substrate 12, and spacer structure 22 are located in a vacuum chamber, the vacuum chamber is evacuated, and the first substrate is then joined to the second substrate with the sidewall 14 between them. Thus, the SED is manufactured having the spacer structure 22.

According to the SED constructed in this manner, the minute indentations 50 are formed on the respective surfaces of the first and second spacers 30a and 30b, and the coating films 54 of the electrically conductive substance are formed on the rugged surfaces, whereby electrification of the spacers can be suppressed. Accordingly, displacement of the electron beams that is attributable to the electrification of the spacers can be prevented to improve the display quality. Further, the coating films 54 are put on the projections of the rugged surfaces and are divided in a plurality of parts. Thus, the resistance value of the spacer surface can be prevented from decreasing, so that generation of electric discharge attributable to the coating films can be suppressed, and the dielectric strength properties can be improved.

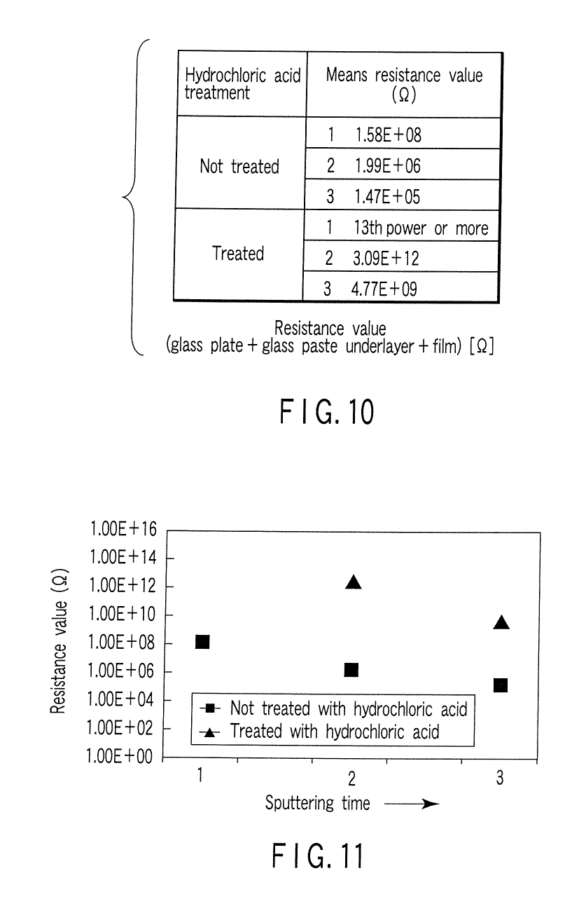

The inventors hereof investigated differences in resistance on spacer surfaces between a case where the electrically conductive substance was put on spacers with rugged surfaces and a case where the electrically conductive substance was put on spacers without indentations. FIGS. 10 and 11 show the results of this investigation. A plurality of test pieces were prepared such that an underlayer of a glass paste with a thickness of 30 μm was formed on the surface of a glass plate and a coating film of chromium oxide was formed on the underlayer. After the underlayer was then immersed in a hydrochloric acid solution to form minute indentations, a plurality of test pieces (treated with hydrochloric acid) formed having the chromium oxide coating film thereon and a plurality of test pieces (not treated with hydrochloric acid) formed having the chromium oxide coating film thereon without any indentations on the underlayer were prepared. For the test pieces, the coating films were formed with the sputtering time changed in three stages (1, 2 and 3). In FIG. 10, the resistance values indicate the sums of resistance values of the glass plate, glass paste, and coating films.

At any of the sputtering times 1, 2 and 3, as seen from FIGS. 10 and 11, the surface resistance values of the test pieces treated with hydrochloric acid are higher by an order of two or more than those of the test pieces not treated with hydrochloric acid. For this reason, generation of electric discharge attributable to the coating films can be suppressed, and the dielectric strength properties can be improved.

Further, the minute indentations 52 are provided on the surface of the supporting substrate 24. If a low-resistance film is put on the supporting substrate surface to suppress emission of secondary electrons from the supporting substrate, therefore, the low-resistance film can be divided by the indentations to become a film of higher resistance. Thus, electric discharge can be inhibited.

In this manner, the SED can be obtained having improved reliability and display quality.

According to the embodiment described above, the minute indentations 50 are configured to be formed on the spacer surfaces after the molding dies are released. In this case, the minute indentations can be worked more easily and at lower cost than the minute indentations that are formed on the spacer surfaces by using molding dies with indentations. Furthermore, the divided coating films can be easily formed by depositing the electrically conductive substance on the rugged surfaces by vapor deposition or sputtering.

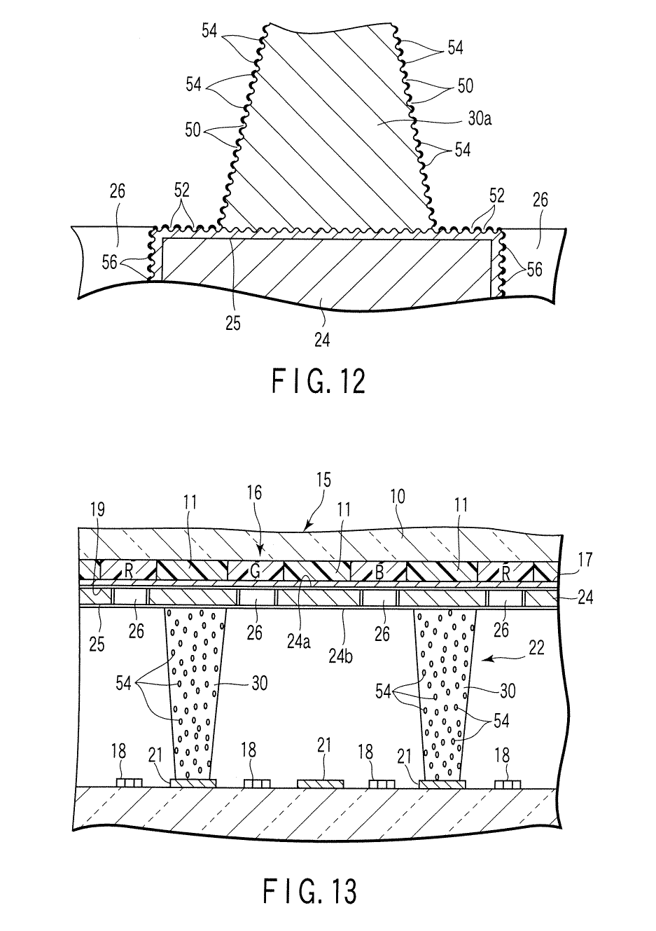

According to the foregoing first embodiment, the minute indentations 52 are provided over the whole area of the dielectric layer 25 of the supporting substrate 24 but those areas on which the first and second spacers 30a and 30b are set up. As in a second embodiment shown in FIG. 12, however, minute indentations 52 with Ra of 0.2 to 0.6 μm and Sm of 0.02 to 0.3 mm may be formed over the whole area of a dielectric layer 25. In this case, first and second spacers 30a and 30b are set up on areas in which the indentations are formed. In the second embodiment, other configurations are the same as those of the foregoing first embodiment, so that like reference numerals are used to designate like portions, and a detailed description thereof is omitted.

According to the configuration described above, the same function and effect of the foregoing first embodiment can be obtained, the adhesion between a supporting substrate 24 and the spacers can be improved, and the strength of the first and second spacers 30a and 30b can be enhanced.

Although the spacer structure according to the foregoing embodiments integrally comprises the first and second spacers and the supporting substrate 24, the second spacers 30b may alternatively be formed on the second substrate 12. Further, the spacer structure may be provided with only a supporting substrate and second spacers such that the supporting substrate is in contact with the first substrate.

The following is a description of an SED according to a third embodiment of this invention. As shown in FIG. 13, a spacer structure 22 has a supporting substrate 24, formed of a rectangular metal plate, and a large number of columnar spacers 30 set up integrally on only one surface of the supporting substrate. The supporting substrate 24 has a first surface 24a opposed to the inner surface of a first substrate 10 and a second surface 24b opposed to the inner surface of a second substrate 12, and is arranged parallel to these substrates. A large number of electron beam apertures 26 are formed in the supporting substrate 24 by etching or the like. The electron beam apertures 26 are arrayed opposite electron emitting elements 18, individually, and are permeated by electron beams emitted from the electron emitting elements.

The first and second surfaces 24a and 24b of the supporting substrate 24 and the respective inner wall surfaces of the electron beam apertures 26 are covered by a high-resistance film as a dielectric layer 25 formed of a dielectric substance that consists mainly of glass or ceramic. The supporting substrate 24 is provided in a manner such that its first surface 24a is in surface contact with the inner surface of the first substrate 10 with a getter film 19, a metal back 17, and a phosphor screen 16 between them. The electron beam apertures 26 in the supporting substrate 24 individually face phosphor layers R, G and B of the phosphor screen 16. Thus, the electron emitting elements 18 face their corresponding phosphor layers through the electron beam apertures 26.

A plurality of spacers 30 are set up integrally on the second surface 24b of the supporting substrate 24. Respective extended ends of the spacers 30 abut against the inner surface of the second substrate 12 or, in this case, wires 21 that are provided on the inner surface of the second substrate 12. Each of the spacers 30 is tapered so that its diameter is reduced from the side of the supporting substrate 24 toward its extended end. Each spacer 30 has an elongated elliptic cross section in a direction parallel to the surface of the supporting substrate 24. The spacer 30 is formed so that a length of its proximal end on the side of the supporting substrate 24 in the longitudinal direction X is about 1 mm, a width in the transverse direction Y is about 300 μm, and a height in the extending direction is about 1.4 mm. The spacers 30 are provided on the supporting substrate 24 in a manner such that their longitudinal direction is in line with the longitudinal direction X of the vacuum envelope.

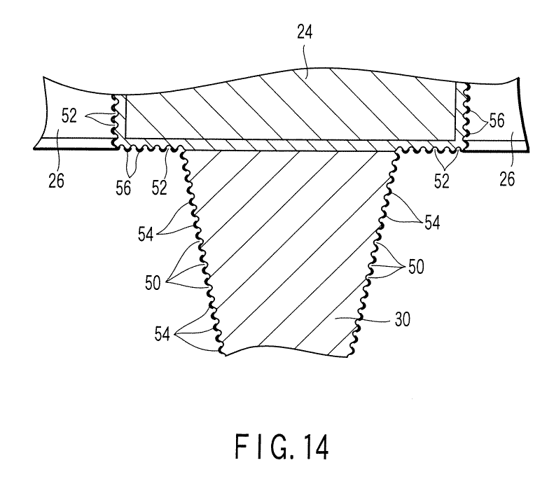

As shown in FIGS. 13 and 14, minute indentations 50 with Ra of 0.2 to 0.6 μm and Sm of 0.02 to 0.3 mm are formed covering the entire surface of the spacers 30. Minute indentations 52 with Ra of 0.2 to 0.6 μm and Sm of 0.02 to 0.3 mm are formed over the whole area of the dielectric layer 25 on the second surface of the supporting substrate 24 except those areas on which the spacers 30 are set up. An electrically conductive substance, e.g., chromium oxide, is put on the rugged surfaces of the spacers 30 and forms divided coating films 54. The coating films 54 are mainly formed on projections of the rugged surfaces.

As in the second embodiment, moreover, the indentations 52 may be formed over the entire surface of the dielectric layer 25. In this case, the spacers 30 are set up on areas in which the indentations are formed. Further, the dielectric layer 25 on the first surface 24a of the supporting substrate 24 may be formed without having the minute indentations 52.

In the spacer structure 22 constructed in this manner, the supporting substrate 24 is in surface contact with the first substrate 10, and the extended ends of the spacers 30 abut against the inner surface of the second substrate 12, thereby supporting the atmospheric load that acts on these substrates and keeping the space between the substrates at a predetermined value.

In the third embodiment, other configurations are the same as those of the foregoing first embodiment, so that like reference numerals are used to designate like portions, and a detailed description thereof is omitted. The SED according to the third embodiment and its spacer structure can be manufactured by a manufacturing method identical to the manufacturing method according to the foregoing embodiments. The same function and effect of the foregoing first embodiment can be also obtained with the third embodiment.

The present invention is not limited directly to the embodiments described above, and its components may be embodied in modified forms without departing from the spirit of the invention. Further, various inventions may be formed by suitably combining a plurality of components described in connection with the foregoing embodiments. For example, some of the components according to the embodiments may be omitted. Furthermore, components according to different embodiments may be combined as required.

Although the spacers are provided on the supporting substrate according to the present invention, the supporting substrate may be omitted. In this case, the spacers are provided directly between the first and second substrates. In the foregoing embodiments, the rugged surfaces are formed on the spacer surfaces and the surface of the supporting substrate, and the divided coating films are formed. However, it is necessary only that at least the surfaces of the spacers be formed into rugged surfaces so that divided coating films of an electrically conductive substance can be formed on the rugged surfaces.

The diameter and height of the spacers and the dimensions, materials, etc., of the other components are not limited to the foregoing embodiments, but may be suitably selected as required. The spacers are not limited to the aforementioned columnar spacers, but plate-like spacers may be used instead. Further, this invention is not limited to image display devices that use surface-conduction electron emitting elements as electron sources, but may be also applied to image display devices that use other electron sources, such as the field-emission type, carbon nanotubes, etc.

What is claimed is:

1. An image display device comprising:
an envelope having a first substrate and a second substrate located opposite the first substrate across a gap;
a plurality of pixels provided in the envelope; and
a plurality of spacers which are provided between the first substrate and the second substrate in the envelope and support an atmospheric load acting on the first and second substrates,
each of the spacers having a rugged surface formed of indentations with an arithmetic mean roughness Ra of 0.2 to 0.6 μm and a mean interval Sm of 0.02 to 0.3 mm, the rugged surface of each spacer having thereon divided coating films of an electrically conductive substance.

2. An image display device comprising:
an envelope having a first substrate and a second substrate located opposite the first substrate across a gap;
a plurality of pixels provided in the envelope; and
a spacer structure which is provided between the first substrate and the second substrate in the envelope and supports an atmospheric load acting on the first and second substrates,
the spacer structure having a supporting substrate provided opposite the first and second substrates and a plurality of spacers set up on at least one surface of the supporting substrate,
a surface of each of spacers having a rugged surface formed of indentations with an arithmetic mean roughness Ra of 0.2 to 0.6 μm and a mean interval Sm of 0.02 to 0.3 mm, the rugged surface having thereon divided coating films of an electrically conductive substance.

3. An image display device according to claim 2, wherein the supporting substrate has a first surface opposed to the first substrate and a second surface opposed to the second substrate, and the spacers include a plurality of first spacers, which are individually set up on the first surface and have an extended end abutting against the first substrate, and a plurality of second spacers, which are individually set up on the second surface and have an extended end abutting against the second substrate.

4. An image display device according to claim 2, wherein the supporting substrate has a first surface opposed to the first substrate and a second surface opposed to the second substrate across a gap, and the spacers are set up on the second surface and have an extended end abutting against the second substrate.

5. An image display device according to claim 2, wherein the surface of the supporting substrate is covered by a dielectric layer, a surface of the dielectric layer having a rugged surface formed of indentations with an arithmetic mean roughness Ra of 0.2 to 0.6 μm and a mean interval Sm of 0.02 to 0.3 mm, and the spacers are set up overlapping the dielectric layer having the indentations thereon.

6. An image display device according to claim 2, wherein the surface of the supporting substrate is covered by a dielectric layer, and the spacers are set up overlapping the dielectric layer, the whole surface of the dielectric layer except those areas on which the spacers are set up having a rugged surface formed of indentations with an arithmetic mean roughness Ra of 0.2 to 0.6 μm and a mean interval Sm of 0.02 to 0.3 mm.

7. A method of manufacturing an image display device which comprises an envelope having a first substrate and a second substrate located opposite the first substrate across a gap, a plurality of pixels provided in the envelope, and a plurality of spacers which are provided between the first substrate and the second substrate in the envelope and support an atmospheric load acting on the first and second substrates, each said spacer having a rugged surface formed of indentations with an arithmetic mean roughness Ra of 0.2 to 0.6 μm and a mean interval Sm of 0.02 to 0.3 mm, the rugged surface of each spacer having thereon divided coating films of an electrically conductive substance, the method comprising:
preparing a molding die having a plurality of spacer forming holes;
loading each spacer forming hole of the molding die with a spacer forming material;
curing the spacer forming material in the spacer forming holes of the molding die and then releasing the cured material from the molding die;
firing the released spacer material, thereby forming the spacers;
partially dissolving the respective surfaces of the formed spacers with an acid-based liquid, thereby forming the indentations with the arithmetic mean roughness Ra of 0.2 to 0.6 μm and the mean interval Sm of 0.02 to 0.3 mm over the whole surfaces of the spacers; and
putting the electrically conductive substance on the rugged spacer surfaces, thereby forming the divided coating films.

8. A method of manufacturing an image display device which comprises an envelope having a first substrate and a second substrate located opposite the first substrate across a gap, a plurality of pixels provided in the envelope, and a spacer structure which is provided between the first substrate and the second substrate in the envelope and supports an atmospheric load acting on the first and second substrates, the spacer structure having a supporting substrate provided opposite the first and second substrates and a plurality of spacers set up on at least one surface of the supporting substrate, the surface of each said spacer having a rugged surface formed of indentations with an arithmetic mean roughness Ra of 0.2 to 0.6 μm and a mean interval Sm of 0.02 to 0.3 mm, the rugged surface having thereon divided coating films of an electrically conductive substance, the method comprising:
preparing a molding die having a plurality of spacer forming holes and a supporting substrate;
covering the surface of the supporting substrate with a dielectric layer;
loading each spacer forming hole of the molding die with a spacer forming material;
curing the spacer forming material after bringing the molding die loaded with the spacer forming material into close contact with the surface of the supporting substrate formed having the dielectric layer;
releasing the molding die transferring the cured spacer forming material onto the surface of the dielectric layer;
firing the released spacer material and the dielectric layer, thereby forming the spacers;
partially dissolving the respective surfaces of the formed spacers and the dielectric layer with an acid-based liquid, thereby forming the indentations with the arithmetic mean roughness Ra of 0.2 to 0.6 μm and the mean interval Sm of 0.02 to 0.3 mm over the surfaces of the spacers and the dielectric layer; and
putting the electrically conductive substance on the rugged spacer surfaces and the supporting substrate surface, thereby forming the divided coating films.
